(19) United States
(12) Patent Application Publication
(10) Pub. No.: US 2012/0141772 A1
(43) Pub. Date: Jun. 7, 2012

(54) LIGHT LIGNOCELLULOSIC MATERIALS HAVING GOOD MECHANICAL PROPERTIES

(75) Inventors: Frank Braun, Ludwigshafen (DE); Olaf Kriha, Neustadt (DE); Klaus Hahn, Kirchheim (DE); Benjamin Nehls, Ludwigshafen (DE); Maxim Paretolchen, Mannheim (DE); Stephan Weinkötz, Neustadt (DE)

(73) Assignee: BASE SE, Ludwigshafen (DE)

(21) Appl. No.: 13/389,515

(22) PCT Filed: Aug. 2, 2010
(86) PCT No.: PCT/EP2010/061172

§ 371 Date: Feb. 8, 2012

(30) Foreign Application Priority Data
Aug. 13, 2009 (EP) 09167780.7

(51) Int. Cl. B32B 3/26; B29C 44/06; B29C 44/10; C08J 9/22; C08J 9/18

(52) U.S. Cl. 428/313.5; 521/84.1; 521/60; 264/45.4

(57) ABSTRACT

A process for the production of a light lignocellulose-containing substance having an average density in the range from 200 to 600 kg/m³, in which, in each case based on the lignocellulose-containing substance:
A) from 30 to 95% by weight of lignocellulose particles;
B) from 1 to 25% by weight of expanded plastics particles having a bulk density in the range from 10 to 100 kg/m³;
C) from 3 to 50% by weight of a binder selected from the group consisting of aminoplast resin, phenol-formaldehyde resin and organic isocyanate having at least two isocyanate groups and, if appropriate
D) additives
   are mixed and then pressed at elevated temperature and under elevated pressure,
   wherein the expanded plastics particles are obtained from expandable plastics particles with a content of blowing agent in the range from 0.01 to 4% by weight, based on the expandable plastics particles.

The present invention relates to a process for the production of a light lignocellulose-containing substance having an average density in the range from 200 to 600 kg/m³, in which, in each case based on the lignocellulose-containing substance:
A) from 30 to 95% by weight of lignocellulose particles;
B) from 1 to 25% by weight of expanded plastics particles having a bulk density in the range from 10 to 100 kg/m³,
C) from 3 to 50% by weight of a binder selected from the group consisting of aminoplast resin, phenol-formaldehyde resin and organic isocyanate having at least two isocyanate groups and, if appropriate
D) additives
   are mixed and then pressed at elevated temperature and under elevated pressure, wherein the expanded plastics particles are obtained from expandable plastics particles with a content of blowing agent in the range from 0.01 to 4% by weight, based on the expandable plastics particles.

The sum of the components A), B), C) and, if appropriate, D) is 100%.

Furthermore, the present invention relates to the use of expandable plastics particles as defined in the claims, to a process for the production of a multilayer lignocellulose material as defined in the claims, and to the use of the light lignocellulose-containing substances according to the invention and of the multilayer lignocellulose material according to the invention as defined in the claims.

Lignocellulose materials, for example wood-base materials, in particular multilayer wood-base materials, are an economical and resource-protecting alternative to solid wood and have become very important in particular in furniture construction, in laminate floors and as construction materials. Wood particles of different thickness, for example woodchips or wood fibers of various timbers, serve as starting materials. Such wood particles are usually pressed with natural and/or synthetic binders and, if appropriate, with addition of further additives to give board- or strand-like wood-base materials.

In order to achieve good mechanical properties of the wood-base materials, these are produced with a density of about 650 kg/m′ or more. For users, in particular private consumers, wood-base materials of this density or the corresponding parts, such as furniture, are often too heavy.

The industrial demand for light wood-base materials has therefore continuously increased in recent years, in particular since items of take-away furniture have become popular. Furthermore, the rising oil price, which leads to a continual increase in costs, for example in the transport costs, is thus giving rise to greater interest in light wood-base materials.

In summary, light wood-base materials are very important for the following reasons:

Light wood-base materials lead to easier handling of the products by the end customer, for example during packing, transporting, unpacking or assembly of the furniture.

Light wood-base materials lead to lower transport and packaging costs; furthermore, material costs can be saved in the production of light wood-base materials.

For example when used in means of transport, light wood-base materials can lead to a lower energy consumption of these means of transport. Furthermore, for example, material-consumptive decorative parts, such as thicker worktops and side panels in kitchens, which are currently in fashion, can be offered more economically with the use of light wood-base materials.

The prior art comprises a variety of proposals for reducing the density of the wood-base materials.

For example, tubular particle boards and honeycomb boards may be mentioned as light wood-base materials which are obtainable by design measures. Owing to their particular properties, tubular particle boards are used mainly as an inner layer in the production of doors.

A disadvantage in the case of a honeycomb board is, for example, the insufficient screw-out resistance, more difficult fastening of fittings and the difficulties in edging.

Furthermore, the prior art comprises proposals for reducing the density of the wood-base materials by additions to the glue or to the wood particles.

CH 370229 describes light and simultaneously pressure-resistant compression moldings which consist of woodchips or wood fibers, a binder and a porous plastic serving as a filler. For the production of the compression moldings, the woodchips or wood fibers are mixed with binder and foamable or partly foamable plastics and the mixture obtained is pressed at elevated temperature. CH 370229 makes no statement concerning the content of blowing agent in the filler polymers.

WO 02/38676 describes a process for the production of light products, in which from 5 to 40% by weight of foamable or already foamed polystyrene having a particle size of less than 1 mm, from 60 to 95% by weight of lignocellulose-containing material and binder are mixed and are pressed at elevated temperature and elevated pressure to give the finished product. WO 02/38676 makes no statement regarding the content of blowing agent in the filler polymers.

WO 2008/046890A (BASF SE), WO 2008/046891 A (BASF SE) and WO 2008/046892 A (BASF SE) describe, inter alia, light wood-containing substances which comprise, for example, woodchips or wood fibers, a binder and a porous plastic serving as a filler. For the production of the wood-containing substances, for example, the woodchips or wood fibers are mixed with binder and foamable or partly foamable plastics and the mixture obtained is pressed at elevated temperature. WO 2008/046890 A, WO 2008/046891 A and WO 2008/046892 A make no statement regarding the content of blowing agent in the filler polymers or the precursors thereof.

In summary, the disadvantage of the prior art is that the precursor polymers used for the production of the foamed fillers comprise relatively large amounts (usually more than 5% by weight, based on the precursor polymers) of blowing agent, for example pentane (mixtures). Most blowing agents, for example pentane, are readily ignitable.

This has the disadvantage that complicated technical measures must be taken in order to prevent the formation of blowing agent/air mixtures which present a fire hazard or are even explosive in the production of the light lignocellulose-containing, for example wood-containing, substances or corresponding, as a rule multilayer, lignocellulose materials, for example wood-base materials.

Usually, the expanded plastics particles, for example polystyrene, with pentane (mixtures) as blowing agent, are temporarily stored for several days in special bins with aeration so that the blowing agent, such as pentane (mixture), can escape. This relatively long storage prevents a continuous production of the light lignocellulose-containing, for example wood-like, substances or corresponding, as a rule multilayer, lignocellulose materials, for example wood-base materials, and may lead to a reduction in production capacity for the light lignocellulose-containing substances, for example wood-like substances, or corresponding, as a rule multilayer, lignocellulose materials, for example wood-base materials.

The object of the present invention was to provide plastics particles for light lignocellulose-containing substances and light lignocellulose-containing materials, which can be produced and handled without a fire hazard and which can be expanded in a controlled manner by relatively simple methods, but lead to lignocellulose-containing, preferably wood-containing, substances and lignocellulose materials, preferably wood-base materials, of low density, having mechanical strengths and good processing properties, for example edgability, which are just as good as those of the prior art.

The mechanical strength can be determined, for example, by measuring the transverse tensile strength according to EN 319.

For evaluating the edgability of the adhesive bonding of edges on particle boards, it is possible to use the TKH data sheet (Technische Komission Holzklebstoffe im Industrieverband Klebstoffe e.V.) from January 2006, Table 10.

Furthermore, the swelling value of the light lignocellulose materials, preferably wood-base materials, should not be adversely affected by the reduced density.

The object was achieved by a process for the production of a light lignocellulose-containing substance having an average density in the range from 200 to 600 kg/m³, in which, in each case based on the lignocellulose-containing substance:
A) from 30 to 95% by weight of lignocellulose particles;
B) from 1 to 25% by weight of expanded plastics particles having a bulk density in the range from 10 to 100 kg/m³;
C) from 3 to 50% by weight of a binder selected from the group consisting of aminoplast resin, phenol-formaldehyde resin and organic isocyanate having at least two isocyanate groups and, if appropriate
D) additives
   are mixed and then pressed at elevated temperature and under elevated pressure, wherein the expanded plastics particles are obtained from expandable plastics particles with a content of blowing agent in the range from 0.01 to 4% by weight, based on the expandable plastics particles.

The terms lignocellulose, lignocellulose particles or lignocellulose-containing substance are known to the person skilled in the art.

Here, lignocellulose-containing substance, lignocellulose-containing particles or lignocellulose particles are, for example, straw or wood parts, such as wood layers, wood strips, woodchips, wood fibers or wood dust, woodchips, wood fibers and wood dust being preferred. The lignocellulose-containing particles or lignocellulose particles may also originate from wood fiber-containing plants, such as flax, hemp.

Starting materials for wood parts or wood particles are usually timbers from the thinning of forests, industrial timbers and used timbers and wood fiber-containing plants.

The processing to give the desired lignocellulose-containing particles, for example wood particles, is effected by known methods, cf. for example M. Dunky, P. Niemt, Holzwerkstoffe and Leime, pages 91-156, Springer Verlag Heidelberg, 2002.

Preferred lignocellulose-containing particles are wood particles, particularly preferably wood fibers, as are used for the production of MDF and HDF boards.

Suitable lignocellulose-containing particles are also flax or hemp particles, particularly preferably flax or hemp fibers, as can be used for the production of MDF and HDF boards.

The lignocellulose-containing, preferable wood-containing, substance may comprise the customary small amounts of water (in a customary small range of variation); this water is not taken into account in the stated weights in the present application.

The stated weight of the lignocellulose particles, preferably wood particles, is based on lignocellulose particles, preferably wood particles, dried in a customary manner known to the person skilled in the art.

The stated weight of the binder is based, with respect to the aminoplast component in the binder, on the solids content of the corresponding component (determined by evaporating the water at 120° C. within 2 h, according, for example, to Günter Zeppenfeld, Dirk Grunwald, Klebstoffe in der Holz—und Möbelindustrie, 2nd edition, DRW-Verlag, page 268) and, with respect to the isocyanate, in particular the PMDI, on the isocyanate component per se, i.e. for example without solvent or emulsifying medium.

The light lignocellulose-containing, preferably wood-containing, substances according to the invention have an average density of from 200 to 600 kg/m³, preferably from 200 to 575 kg/m³, particularly preferably from 250 to 550 kg/m³, in particular from 300 to 500 kg/m³.

The transverse tensile strength of the light lignocellulose-containing, preferably wood-containing, substances according to the invention or preferably of the multilayer lignocellulose materials, particularly preferably multilayer wood-base materials, according to the invention is in general in the range from 0.1 N/mm² to 1.0 N/mm², preferably from 0.3 to 0.8 N/mm², particularly preferably from 0.4 to 0.6 N/mm².

The transverse tensile strength is determined according to EN 319.

Suitable multilayer lignocellulose materials are all materials which are produced from lignocellulose veneers, preferably wood veneers, preferably having an average density of the wood veneers from 0.4 to 0.85 g/cm³, for example veneer boards or plywood boards or laminated veneer lumber (LVL).

Suitable multilayer lignocellulose materials, preferably multilayer wood-base materials, are particularly preferably all materials which are produced from lignocellulose chips, preferably woodchips, preferably having an average density of the woodchips of from 0.4 to 0.85 g/cm³, for example particle boards or OSB boards, and wood fiber materials, such as LDF, MDF and HDF boards. Particle boards and fiber boards, in particular particle boards, are preferred.

The average density of the lignocellulose particles, preferably of the wood particles, of component A) is as a rule from 0.4 to 0.85 g/cm³, preferably from 0.4 to 0.75 g/cm³, in particular from 0.4 to 0.6 g/cm³.

Any desired type of wood is suitable for producing the wood particles; for example, spruce, beech, pine, larch, linden, poplar, ash, chestnut and fir wood are very suitable, and spruce and/or beech wood, in particular spruce wood, are preferred.

The dimensions of the lignocellulose particles, preferably wood particles, are not critical and depend as usual on the lignocellulose material, preferably wood-base material, to be produced, for example the abovementioned wood-base materials, such as particle boards or OSB.

Component B) comprises expanded plastics particles, preferably expanded thermoplastic particles.

Such expanded plastics particles are usually obtained as follows: compact plastics particles which comprise an expandable medium (frequently also referred to as “blowing agent”) are expanded by the action of heat energy or pressure change (often also referred to as “foamed”). Here, the blowing agent expands, the particles increase in size and cell structures result.

The expansion can be carried out in one stage or a plurality of stages. As a rule, in the one-stage process, the expandable plastics particles are expanded directly to the desired final size.

As a rule, in the multistage process, the expandable plastics particles are first expanded to an intermediate size and then expanded in one or more further stages by a corresponding number of intermediate sizes to the desired final size.

The abovementioned compact plastic particles, also referred to herein as “expandable plastics particles”, comprise as a rule no cell structures, in contrast to the expanded plastics particles.

Suitable polymers on which the expandable or expanded plastics particles are based are all polymers, preferably thermoplastic polymers, which can be foamed. These are known to the person skilled in the art.

Suitable such polymers are, for example, polyketones, polysulfones, polymethylene, PVC (rigid and flexible), polycarbonates, polyisocyanurates, polycarbodiimides, polyacrylimides and polymethacrylimides, polyamides, polyurethanes, aminoplast resins and phenol resins, styrene homopolymers (also referred to below as “polystyrene” or “styrene polymer”), styrene copolymers, C₂-C₁₀-olefin homopolymers, C₂-C₁₀-olefin copolymers and polyesters. The 1-alkenes, for example ethylene, propylene, 1-butene, 1-hexene, 1-octene, are preferably used for the preparation of said olefin polymers.

The expanded plastics particles of component B) have a bulk density of from 10 to 100 kg/m³, preferably from 15 to 90 kg/m³, particularly preferably from 20 to 80 kg/m³, in particular from 40 to 80 kg/m³.

The bulk density is usually determined by weighing a defined volume filled with the bulk material.

Expanded plastics particles B) are generally used in the form of spheres or beads having an average diameter of, advantageously, from 0.25 to 10 mm, preferably from 0.4 to 8.5 mm, in particular from 0.4 to 7 mm.

Expanded particulate plastics spheres or beads B) advantageously have a small surface area per unit volume, for example in the form of a spherical or elliptical particle.

The expanded particulate plastics spheres B) advantageously have closed cells. The proportion of open cells according to DIN-ISO 4590 is as a rule less than 30%.

If the component B) consists of different polymer types, i.e. polymer types which are based on different monomers (for example polystyrene and polyethylene or polystyrene and homopolypropylene or polyethylene and homopolypropylene), these may be present in different weight ratios which, however, according to the current state of knowledge, are not critical.

Furthermore, additives, for example UV stabilizers, antioxidants, coating materials, water repellents, nucleating agents, plasticizers, flameproofing agents, soluble and insoluble inorganic and/or organic dyes, pigments and athermanous particles, such as carbon black, graphite or aluminum powder, can be added, together or spatially separately, as additives to the polymers, preferably the thermoplastics, on which the expandable or expanded plastics particles B) are based.

All blowing agents known to the person skilled in the art, for example aliphatic C₃- to C₁₀-hydrocarbons, such as propane, n-butane, isobutane, n-pentane, isopentane, neopentane, cyclopentane and/or hexane, and isomers thereof, alcohols, ketones, esters, ethers or halogenated hydrocarbons, can be used for expanding the expandable plastics particles.

The content of blowing agent in the expandable plastics particles is in the range from 0.01 to 4% by weight, preferably from 0.1 to 4% by weight, particularly preferably from 0.5 to 3.5% by weight, based in each case on the expandable plastics particles containing blowing agent.

Polystyrene and/or styrene copolymer are preferably used as the sole plastics particle component in component B).

Such polystyrene and/or styrene copolymer can be prepared by all polymerization processes known to the person skilled in the art, cf. for example Ullmann's Encyclopedia, Sixth Edition, 2000 Electronic Release, or Kunststoff-Handbuch 1996, volume 4 “Polystyrol”, pages 567 to 598.

The preparation of the expandable polystyrene and/or styrene copolymer is effected as a rule in a manner known per se by suspension polymerization or by means of extrusion processes.

In the suspension polymerization, styrene, if appropriate with addition of further comonomers, is polymerized in aqueous suspension in the presence of a customary suspension stabilizer by means of catalysts forming free radicals. The blowing agent and, if appropriate, further additives can be concomitantly initially taken in the polymerization or added to the batch in the course of the polymerization or after the end of the polymerization. The bead-like, expandable styrene polymers obtained, which are impregnated with blowing agent, are separated from the aqueous phase after the end of polymerization, washed, dried and screened.

In the extrusion process, the blowing agent is mixed into the polymer for example via an extruder, transported through a die plate and granulated under pressure to give particles or strands.

All blowing agents known to the person skilled in the art and already mentioned above are used as blowing agents for the preparation of the expandable polystyrene and/or styrene copolymer, for example aliphatic C₃- to C₁₀-hydrocarbons, such as propane, n-butane, isobutane, n-pentane, isopentane, neopentane, cyclopentane and/or hexane and isomers thereof, alcohols, ketones, esters, ethers or halogenated hydrocarbons.

The blowing agent is preferably selected from the group consisting of n-pentane, isopentane, neopentane and cyclopentane. A commercially available pentane isomer mixture comprising n-pentane and isopentane is particularly preferably used.

The content of blowing agent in the expandable polystyrene or styrene copolymer is in the range from 0.01 to 4% by weight, preferably from 0.1 to 4% by weight, particularly preferably from 0.5 to 3.5% by weight, based in each case on the expandable polystyrene or styrene copolymer containing blowing agent.

The content of C₃- to C₁₀-hydrocarbons as blowing agent in the expandable polystyrene or styrene copolymer is in the range from 0.01 to 4% by weight, preferably from 0.1 to 4% by weight, particularly preferably from 0.5 to 3.5% by weight, based in each case on the expandable polystyrene or styrene copolymer containing blowing agent.

The content of blowing agent selected from the group consisting of n-pentane, isopentane, neopentane and cyclopentane in the expandable polystyrene or styrene copolymer is in the range from 0.01 to 4% by weight, preferably from 0.1 to 4% by weight, particularly preferably from 0.5 to 3.5% by weight, based in each case on the expandable polystyrene or styrene copolymer containing blowing agent.

The content of blowing agent selected from the group consisting of n-pentane, isopentane, neopentane and cyclopentane in the expandable polystyrene is in the range from 0.01 to 4% by weight, preferably from 0.1 to 4% by weight, particularly preferably from 0.5 to 3.5% by weight, based in each case on the expandable polystyrene containing blowing agent.

The above-described styrene polymers or styrene copolymers have a relatively low content of blowing agent. Such polymers are also referred to as “low in blowing agent”. A suitable process for preparation of expandable polystyrene or styrene copolymer low in blowing agent is described in U.S. Pat. No. 5,112,875, which is hereby incorporated by reference.

Furthermore, additives, for example UV stabilizers, antioxidants, coating materials, water repellents, nucleating agents, plasticizers, flameproofing agents, soluble and insoluble inorganic and/or organic dyes, pigments and athermanous particles, such as carbon black, graphite or aluminum powder, can be added, together or spatially separately, as additives to the styrene polymers or styrene copolymers.

As described, styrene copolymers can also be used. Advantageously, these styrene copolymers have at least 50% by weight, preferably at least 80% by weight, of styrene incorporated in the form of polymerized units. Suitable comonomers are, for example, α-methylstyrene, styrenes halogenated on the nucleus, acrylonitrile, esters of acrylic or methacrylic acid with alcohols having 1 to 8 carbon atoms, N-vinylcarbazole, maleic acid(anhydride), (meth)acrylamides and/or vinyl acetate.

Advantageously, the polystyrene and/or styrene copolymer may comprise a small amount of a chain-branching agent incorporated in the form of polymerized units, i.e. of a compound having more than one double bond, preferably two double bonds, such as divinylbenzene, butadiene and/or butanediol diacrylate. The branching agent is generally used in amounts of from 0.0005 to 0.5 mol %, based on styrene.

Preferably, styrene polymers or styrene copolymers having a molecular weight in the range from 70 000 to 400 000 g/mol, particularly preferably from 190 000 to 400 000 g/mol, very particularly preferably from 210 000 to 400 000 g/mol, are used.

Mixtures of different styrene (co)polymers may also be used.

Suitable styrene polymers or styrene copolymers are crystal-clear polystyrene (GPPS), high impact polystyrene (HIPS), anionically polymerized polystyrene or impact-resistant polystyrene (A-IPS), styrene-α-methylstyrene copolymers, acrylonitrile-butadiene-styrene polymers (ABS), styrene-acrylonitrile (SAN), acrylonitrile-styrene-acrylate (ASA), methyl acrylate-butadiene-styrene (MBS), methyl methacrylate-acrylonitrile-butadiene-styrene (MABS) polymers or mixtures thereof or with polyphenylene ether (PPE).

Particularly preferably, a styrene homopolymer having a molecular weight in the range from 70 000 to 400 000 g/mol, particularly preferably from 190 000 to 400 000 g/mol, very particularly preferably from 210 000 to 400 000 g/mol, is used.

For the preparation of expanded polystyrene as component B) and/or expanded styrene copolymer as component B), in general the expandable styrene homopolymers or expandable styrene copolymers are expanded in a known manner by heating to temperatures above their softening point, for example by hot air or preferably steam, as described, for example, in Kunststoff Handbuch 1996, volume 4 “Polystyrol”, Hanser 1996, pages 640 to 673, or U.S. Pat. No. 5,112,875.

The expansion can be carried out in one stage or a plurality of stages. As a rule, in the one-stage process, the expandable styrene homopolymer or expandable styrene copolymer is expanded directly to the desired final size.

As a rule, in the multistage process, the expandable styrene homopolymer or expandable styrene copolymer is first expanded to an intermediate size and then expanded in one or more further stages via a corresponding number of intermediate sizes to the desired final size.

Preferably, the expansion is carried out in one stage.

The content of blowing agent in the expanded styrene homopolymer (polystyrene) or expanded styrene copolymer, preferably expanded styrene homopolymer (polystyrene), is in the range from 0 to 3.5% by weight, preferably from 0 to 3% by weight, particularly preferably from 0 to 2.5% by weight, very particularly preferably from 0 to 2% by weight, based in each case on the expanded styrene homopolymer (polystyrene) or styrene copolymer.

Here, 0% by weight means that no blowing agent can be detected by the customary detection methods.

The expanded styrene homopolymer (polystyrene), or expanded styrene copolymer advantageously has a bulk density of from 10 to 100 kg/m³, preferably from 15 to 90 kg/m³, particularly preferably from 20 to 80 kg/m³, in particular from 40 to 80 kg/m³.

The expanded polystyrene or expanded styrene copolymer is advantageously used in the form of spheres or beads having a mean diameter in the range from 0.25 to 10 mm, preferably in the range from 0.4 to 8.5 mm, in particular in the range from 0.4 to 7 mm.

The expanded polystyrene spheres or expanded styrene copolymer spheres advantageously have a small surface area per unit volume, for example in the form of a spherical or elliptical particle.

The expanded polystyrene or expanded styrene copolymer spheres advantageously have closed cells. The proportion of open cells according to DIN-ISO 4590 is as a rule less than 30%.

Usually, the expandable polystyrene or expandable styrene copolymer or the expanded polystyrene or expanded styrene copolymer has an antistatic coating.

Substances usual and customary in industry can be used as antistatic agents. Examples are N,N-bis(2-hydroxyethyl)-C₁₂-C₁₈-alkylamines, fatty acid diethanolamides, choline ester chlorides of fatty acids, C₁₂-C₂₀-alkylsulfonates, ammonium salts.

Suitable ammonium salts comprise, on the nitrogen, in addition to alkyl groups, from 1 to 3 organic radicals containing hydroxyl groups.

Suitable quaternary ammonium salts are, for example, those which comprise from 1 to 3, preferably 2, identical or different alkyl radicals having 1 to 12, preferably 1 to 10, carbon atoms and 1 to 3, preferably 2, identical or different hydroxyalkyl or hydroxy-alkylpolyoxyalkylene radicals bonded to the nitrogen cation, with any desired anion, such as chloride, bromide, acetate, methylsulfate or p-toluenesulfonate.

The hydroxyalkyl and hydroxyalkylpolyoxyalkylene radicals are those which form as a result of oxyalkylation of a nitrogen-bonded hydrogen atom and are derived from 1 to 10 oxyalkylene radicals, in particular oxyethylene and oxypropylene radicals.

A quaternary ammonium salt or an alkali metal salt, in particular sodium salt, of a C₁₂-C₂₀ alkanesulfonate or a mixture thereof is particularly preferably used as an antistatic agent. The antistatic agents can be added as a rule both as pure substance and in the form of an aqueous solution.

In the process for the preparation of polystyrene or styrene copolymer, the antistatic agent can be added in an analogous manner to the customary additives or can be applied as a coating after the production of the polystyrene particles.

The antistatic agent is advantageously used in an amount of from 0.05 to 6% by weight, preferably from 0.1 to 4% by weight, based on the polystyrene or styrene copolymer.

The expanded plastics particles B) are advantageously present in a state in which their original form is still recognizable, even after the pressing to give the light lignocellulose material, preferably light wood-base material, preferably multilayer lignocellulose material, particularly preferably multilayer wood-base material. Melting of the expanded plastics particles which are present on the surface of the light lignocellulose-containing, preferably light wood-containing, substance or preferably of the multilayer lignocellulose material, preferably wood-base material, may occur.

The total amount of the expanded plastics particles B), based on the light lignocellulose-containing, preferably light wood-containing, substance is in the range from 1 to 25% by weight, preferably 3 to 15% by weight, particularly preferably 3 to 12% by weight.

The total amount of the expanded plastics particles B) with polystyrene and/or styrene copolymer as the sole particulate plastics component, based on the light lignocellulose-containing, preferably light wood-containing, substance, is in the range from 1 to 25% by weight, preferably 3 to 15% by weight, particularly preferably 3 to 12% by weight.

The matching of the dimensions of the expanded plastics particles B) described above, preferably expanded styrene polymer particles or expanded styrene copolymer particles, to the lignocellulose particles, preferably wood particles A), or vice versa, has proven advantageous.

This matching is expressed below by the relationship of the respective d′ values (from the Rosin-Rammler-Sperling-Bennet function) of the lignocellulose particles, preferably wood particles A), and of the expanded plastics particles B).

The Rosin-Rammler-Sperling-Bennet function is described, for example, in DIN 66145.

For determining the d′ values, sieve analyses are first carried out for determining the particle size distribution of the expanded plastics particles B) and lignocellulose particles, preferably wood particles A), analogously to DIN 66165, parts 1 and 2.

The values from the sieve analysis are then inserted into the Rosin-Rammler-Sperling-Bennet function and d′ is calculated.

The Rosin-Rammler-Sperling-Bennet function is:

R=100*exp(−(d/d′)ⁿ))

with the following meanings of the parameters:
R residue (% by weight) which remains on the respective sieve tray
d particle size
d′ particle size at 36.8% by weight of residue
n width of the particle size distribution

Suitable lignocellulose particles, preferably wood particles A), have a d′ value, according to Rosin-Rammler-Sperling-Bennet (definition and determination of the d′ value as described above), in the range from 0.1 to 5.0, preferably in the range from 0.3 to 3.0 and particularly preferably in the range from 0.5 to 2.75.

Suitable light lignocellulose-containing, preferably wood-containing, substances or multilayer lignocellulose materials, preferably multilayer wood-base materials, are obtained if the following relationship is true for the d′ values, according to Rosin-Rammler-Sperling-Bennet, of the lignocellulose particles, preferably wood particles A), and the particles of the expanded plastics particles B):

d′ of the particles A) ≦2.5×d′ of the particles B), preferably
d′ of the particles A) ≦2.0×d′ of the particles B), particularly preferably
d′ of the particles A) ≦1.5×d′ of the particles B), very particularly preferably
d′ of the particles A) ≦d′ of the particles B).

The binder C) is selected from the group consisting of aminoplast resin, phenol-formaldehyde resin and organic isocyanate having at least two isocyanate groups. In the present application, the absolute and percentage quantity data with respect to the component C) are based on these components.

The binder C) comprises, as a rule, the substances known to the person skilled in the art, generally used for aminoplasts or phenol-formaldehyde resins and usually referred to as curing agents, such as ammonium sulfate or ammonium nitrate or inorganic or organic acids, for example sulfuric acid, formic acid, or acid-regenerating substances, such as aluminum chloride, aluminum sulfate, in each case in the customary, small amounts, for example in the range from 0.1% by weight to 3% by weight, based on the total amount of aminoplast resin in the binder C).

Phenol-formaldehyde resins (also referred to as PF resins) are known to the person skilled in the art, cf. for example Kunststoff-Handbuch, 2nd edition, Hanser 1988, volume 10 “Duroplaste”, pages 12 to 40.

Here, aminoplast resin is understood as meaning polycondensates of compounds having at least one carbamide group optionally partly substituted by organic radicals (the carbamide group is also referred to as carboxamide group) and an aldehyde, preferably formaldehyde.

All aminoplast resins known to the person skilled in the art, preferably those known for the production of wood-base materials, can be used as suitable aminoplast resin. Such resins and their preparation are described, for example, in Ullmanns Enzyklopädie der technischen Chemie, 4th newly revised and extended edition, Verlag Chemie, 1973, pages 403 to 424 “Aminoplaste”, and Ullmann's Encyclopedia of Industrial Chemistry, Vol. A2, VCH Verlagsgesellschaft, 1985, pages 115 to 141 “Amino Resins”, and in M. Dunky, P. Niemz, Holzwerkstoffe and Leime, Springer 2002, pages 251 to 259 (UF resins) and pages 303 to 313 (MUF and UF with a small amount of melamine).

Preferred aminoplast resins are polycondensates of compounds having at least one carbamide group, also partly substituted by organic radicals, and formaldehyde. Particularly preferred aminoplast resins are urea-formaldehyde resins (UF resins), melamine-formaldehyde resins (MF resins) or melamine-containing urea-formaldehyde resins (MUF resins).

Very particularly preferred aminoplast resins are urea-formaldehyde resins, for example Kaurit® glue types from BASF SE.

Further very preferred aminoplast resins are polycondensates of compounds having at least one amino group, also partly substituted by organic radicals, and aldehyde, in which the molar ratio of aldehyde to amino group optionally partly substituted by organic radicals is in the range from 0.3 to 1.0, preferably from 0.3 to 0.60, particularly preferably from 0.3 to 0.45, very particularly preferably from 0.30 to 0.40.

Further very preferred aminoplast resins are polycondensates of compounds having at least one amino group —NH₂ and formaldehyde, in which the molar ratio of formaldehyde to —NH₂ group is in the range from 0.3 to 1.0, preferably from 0.3 to 0.60, particularly preferably from 0.3 to 0.45, very particularly preferably from 0.30 to 0.40.

Further very preferred aminoplast resins are urea-formaldehyde resins (UF resins), melamine-formaldehyde resins (MF resins) or melamine-containing urea-formaldehyde resins (MUF resins), in which the molar ratio of formaldehyde to —NH₂ group is in the range from 0.3 to 1.0, preferably from 0.3 to 0.60, particularly preferably from 0.3 to 0.45, very particularly preferably from 0.30 to 0.40.

Further very preferred aminoplast resins are urea-formaldehyde resins (UF resins) in which the molar ratio of formaldehyde to —NH₂ group is in the range from 0.3 to 1.0, preferably from 0.3 to 0.60, particularly preferably from 0.3 to 0.45, very particularly preferably from 0.30 to 0.40.

Said aminoplast resins are usually used in liquid form, generally suspended in a liquid suspending medium, preferably in aqueous suspension, but can also be used as a solid.

The solids content of the aminoplast resin suspensions, preferably aqueous suspension, is usually from 25 to 90% by weight, preferably from 50 to 70% by weight.

The solids content of the aminoplast resin in aqueous suspension can be determined according to Günter Zeppenfeld, Dirk Grunwald, Klebstoffe in der Holz- and Möbelindustrie, 2nd edition, DRW-Verlag, page 268. For determining the solids content of aminoplast glues, 1 g of aminoplast glue is accurately weighed into a weighing dish, finely distributed over the bottom and dried for 2 hours at 120° C. in a drying oven. After cooling to room temperature in a desiccator, the residue is weighed and is calculated as a percentage of the weight taken.

The aminoplast resins are prepared by known processes (cf. abovementioned Ullmann literature “Aminoplaste” and “Amino Resins”, and abovementioned literature Dunky et al.) by reacting the compounds containing carbamide groups, preferably urea and/or melamine, with the aldehydes, preferably formaldehyde, in the desired molar ratios of carbamide group to aldehyde, preferably in water as a solvent.

The desired molar ratio of aldehyde, preferably formaldehyde, to amino group optionally partly substituted by organic radicals can also be established by addition of monomers carrying —NH₂ groups to formaldehyde-richer prepared, preferably commercial, aminoplast resins. Monomers carrying NH₂ groups are preferably urea or melamine, particularly preferably urea.

A further component of the binder C) may be an organic isocyanate having at least two isocyanate groups.

All organic isocyanates known to the person skilled in the art, preferably those known for the production of wood-base materials or polyurethanes, can be used as a suitable organic isocyanate. Such organic isocyanates and their preparation and use are described, for example, in Becker/Braun, Kunststoff Handbuch, 3rd newly revised edition, volume 7 “Polyurethane”, Hanser 1993, pages 17 to 21, pages 76 to 88 and pages 665 to 671.

Preferred organic isocyanates are oligomeric isocyanates having 2 to 10, preferably 2 to 8, monomer units and on average at least one isocyanate group per monomer unit.

A particularly preferred organic isocyanate is the oligomeric organic isocyanate PMDI (“polymeric methylenediphenylene diisocyanate”), which is obtainable by condensation of formaldehyde with aniline and phosgenation of the isomers and oligomers formed in the condensation (cf. for example Becker/Braun, Kunststoff Handbuch, 3rd newly revised edition, volume 7 “Polyurethane”, Hanser 1993, page 18, last paragraph to page 19, second paragraph, and page 76, fifth paragraph).

PMDI products which are very suitable in the context of the present invention are the products of the LUPRANAT® series from BASF SE, in particular LUPRANAT® M 20 FB from BASF SE.

It is also possible to use mixtures of the organic isocyanates described, the mixing ratio not being critical according to the current state of knowledge.

The resin constituents of the binder C) can be used by themselves, i.e. for example aminoplast resin as the sole resin constituent of the binder C), or organic isocyanate as the sole resin constituent of the binder C) or PF resin as the sole constituent of the binder C).

The resin constituents of the binder C) can, however, also be used as a combination of two or more resin constituents of the binder C).

The total amount of the binder C), based on the light wood-containing substance, is in the range from 3 to 50% by weight, preferably from 5 to 15% by weight, particularly preferably from 7 to 10% by weight.

Here, the total amount of the aminoplast resin (always based on the solid), preferably the urea-formaldehyde resin and/or melamine-urea-formaldehyde resin and/or melamine-formaldehyde resin, particularly preferably urea-formaldehyde resin, in the binder C), based on the light lignocellulose-containing, preferably light wood-containing, substance, is generally in the range from 1 to 45% by weight, preferably 4 to 14% by weight, particularly preferably 6 to 9% by weight.

Here, the total amount of the organic isocyanate, preferably of the oligomeric isocyanate having 2 to 10, preferably 2 to 8, monomer units and an average of at least one isocyanate group per monomer unit, particularly preferably PMDI, in the binder C), based on the light lignocellulose-containing, preferably light wood-containing, substance is generally in the range from 0 to 5% by weight, preferably from 0.1 to 3.5% by weight, particularly preferably from 0.5 to 1.5% by weight.

The ratios of the aminoplast resin to the organic isocyanate arise from the above-described ratios of the aminoplast resin binder to light lignocellulose-containing, preferably light wood-containing, substance or of the organic isocyanate binder to light lignocellulose-containing, preferably light wood-containing, substance.

Preferred embodiments of a light wood-containing substance comprise from 55 to 92.5% by weight, preferably from 60 to 90% by weight, in particular from 70 to 88% by weight, based on the light wood-containing substance, of wood particles, the wood particles having an average density of from 0.4 to 0.85 g/cm³, preferably from 0.4 to 0.75 g/cm³, in particular from 0.4 to 0.6 g/cm³, from 3 to 25% by weight, preferably from 3 to 15% by weight, in particular from 3 to 10% by weight, based on the light wood-containing substance, of expanded polystyrene and/or expanded styrene copolymer as component B) having a bulk density of from 10 to 100 kg/m³, preferably from 20 to 80 kg/m³, in particular from 30 to 60 kg/m³, and from 3 to 40% by weight, preferably from 5 to 25% by weight, in particular from 5 to 15% by weight, based on the light wood-containing substance, of binder C), the total amount of the aminoplast resin, preferably of the urea-formaldehyde resin and/or melamine-urea-formaldehyde resin and/or melamine-formaldehyde resin, particularly preferably urea-formaldehyde resin, in the binder C), based on the light wood-containing substance, being in the range from 1 to 45% by weight, preferably 4 to 14% by weight, particularly preferably 6 to 9% by weight, and the average density of the light wood-containing substance being in the range from 200 to 600 kg/m³, preferably in the range from 300 to 575 kg/m³.

If appropriate, further commercially available additives known to the person skilled in the art may be present as component D) in the light lignocellulose-containing, preferably light wood-containing, substance according to the invention or the multilayer lignocellulose material, preferably multilayer wood-base material, according to the invention, for example water repellents, such as paraffin emulsions, antifungal agents, formaldehyde scavengers, for example urea or polyamines, and flameproofing agents.

The present invention furthermore relates to a process for the production of a multilayer lignocellulose material, preferably wood-base material, which comprises at least three lignocellulose material layers, preferably wood-base material layers, at least the middle layer(s) comprising a light lignocellulose-containing, preferably light wood-containing substance having an average density in the range from 200 to 600 kg/m³ and having further features as described above and in the claims, and the components for the individual layers being placed in layers one on top of the other and pressed at elevated temperature and elevated pressure, and the expanded plastics particles B) being obtained from expandable plastics particles with a content of blowing agent in the range from 0.01 to 4% by weight, based on the expandable plastics particles.

Preferred parameter ranges and preferred embodiments with regard to the average density of the light lignocellulose-containing substance, preferably light wood-containing substance and with regard to the components A), B), C) and D) and the combination of the features correspond to the above description.

The processes for the production of multilayer lignocellulose materials, preferably wood-base materials are known in principle and are described, for example, in M. Dunky, P. Niemz, Holzwerkstoffe and Leime, Springer 2002, pages 91 to 150.

A process for the production of a multilayer lignocellulose material according to the invention is described below using the example of the production of a multilayer wood-base material according to the invention.

After chipping of the wood, the chips are dried. If appropriate, coarse and fine fractions are then removed. The remaining chips are sorted by screening or classification in an air stream. The coarser material is used for the middle layer and the finer material for the covering layers.

Middle layer and covering layer chips are mixed (“glue-coated”) separately from one another in each case with the components B) (only the middle layer(s)), C) (middle layer) and, if appropriate, D) (middle layer and/or covering layers), and with an aminoplast resin (covering layer) and then sprinkled.

First, the covering layer material is sprinkled onto the shaping belt, then the middle layer material—comprising the components B), C) and, if appropriate, D)—and finally once again covering layer material. The three-layer chip cake thus produced is precompacted while cold (as a rule at room temperature) and then hot-pressed.

The pressing can be effected by all methods known to the person skilled in the art. Usually, the wood particle cake is pressed at a press temperature of from 150° C. to 230° C. to the desired thickness. The duration of pressing is usually from 3 to 15 seconds per mm board thickness. A three-layer particle board is obtained.

The average density of multilayer lignocellulose material according to the invention, preferably of the three-layer lignocellulose material according to the invention, preferably wood-base material, is in the range from 300 kg/m³ to 600 kg/m³, preferably in the range from 350 kg/m³ to 600 kg/m³, particularly preferably in the range from 400 kg/m³ to 500 kg/m³.

Middle layers in the context of the invention are all layers which are not the outer layers.

Preferably, the outer layers (usually referred to as “covering layer(s)”) have no component B).

Preferably, the multilayer lignocellulose material, preferably multilayer wood-base material, according to the invention comprises three lignocellulose layers, preferably layers of pulp material, the outer covering layers together making up from 1 to 25% of the total thickness of the multilayer lignocellulose material, preferably wood-base material, according to the invention, preferably from 3 to 20%, in particular from 5 to 15%.

The binder used for the outer layers is usually an aminoplast resin, for example urea-formaldehyde resin (UF), melamine-formaldehyde resin (MF), melamine-urea-formaldehyde resin (MUF) or the binder C) according to the invention. The binder used for the outer layers is preferably an aminoplast resin, particularly preferably a urea-formaldehyde resin, very particularly preferably an aminoplast resin in which the molar ratio of formaldehyde to —NH₂ groups is in the range from 0.3 to 1.0.

The thickness of the multilayer lignocellulose material, preferably wood-base material, according to the invention varies with the field of use and is as a rule in the range from 0.5 to 100 mm, preferably in the range from 10 to 40 mm, in particular from 15 to 20 mm.

Furthermore, the present invention relates to the use of the light lignocellulose-containing, preferably light wood-containing, substance according to the invention and of the multilayer lignocellulose material, preferably multilayer wood-base material, according to the invention for the production of articles of all kinds, for example furniture, furniture parts or packaging materials, the use of the light lignocellulose-containing substance, preferably light wood-containing substance, according to the invention and of the multilayer lignocellulose material, preferably multilayer wood-base material, according to the invention in the construction sector. Examples of articles of all kinds in addition to pieces of furniture, furniture parts and packaging materials are wall and ceiling elements, doors and floors.

Examples of furniture or furniture parts are kitchen furniture, cabinets, chairs, tables, worktops, for example for kitchen furniture, desktops.

Examples of packaging materials are crates and boxes.

Examples for the construction sector are building construction, civil engineering, interior finishing, internal construction, where the lignocellulose-containing substances, preferably light wood-containing substances, according to the invention or multilayer lignocellulose materials, preferably wood-base materials, according to the invention can be used as formwork boards or as supports.

The advantages of the present invention are the low density of the light lignocellulose-containing substance, preferably light wood-containing substance, according to the invention or multilayer lignocellulose material, preferably multilayer wood-base material, according to the invention, good mechanical stability being maintained.

Furthermore, the light lignocellulose-containing substance, preferably light wood-containing substance, according to the invention and multilayer lignocellulose material, preferably multilayer wood-base material, according to the invention can be produced easily; there is no need to convert the existing plants of the wood-base materials industry for the production of the multilayer lignocellulose materials, preferably multilayer wood-base materials, according to the invention.

The edging properties of the light wood-containing substances according to the invention or particularly of the multilayer wood-base materials are surprisingly good. The edge adheres particularly well and is not uneven or wavy, the narrow surface, in particular of the multilayer wood-base material, does not show through the edge, the edge is stable to pressure and the edging can be effected using the customary machines of board production and edging.

Surprisingly, even low-formaldehyde glues, i.e. usually glues having a low molar ratio of formaldehyde to —NH₂ groups in the range from 0.3 to 1.0, preferably from 0.3 to 0.6, lead to light lignocellulose-containing, preferably light wood-containing, substances or multilayer lignocellulose materials, preferably wood-base substances, the mechanical properties, for example the transverse tensile strength, of such light lignocellulose-containing substances, preferably light wood-containing substances or multilayer lignocellulose materials, preferably multilayer wood-base substances, being unexpectedly high.

The swelling values of the multilayer lignocellulose materials, preferably multilayer wood-base substances, according to the invention are lower than the swelling values of an analogous board of the same density without component B).

An advantage of the invention is that the expanded plastics particles which were obtained from the expandable (compact) plastics particles with a low blowing agent content need no longer be temporarily stored for a long time, if at all, in order to reduce the content of flammable blowing agent before the further processing of the expanded plastics particles to give the lignocellulose material, for example particle board.

### EXAMPLES

### A) Preparation of the Expanded Polystyrene Having a Low Pentane Content

In an extruder, 95 parts by weight of polystyrene 158 K (BASF SE), 0.2 parts by weight of Luwax AH3 (BASF SE) were mixed together with 3.5 parts by weight of pentane (a commercially available pentane isomer mixture comprising n-pentane and isopentane). The resulting polymer melt was transported through a die plate and pelletized with the aid of pressurized underwater pelletization to give expandable particles.

The expandable particles were treated with steam in a continuous conventional pre-expander. By varying the steam application pressure and the steam application time, a bulk density of 50 kg/m³ of the expanded polystyrene particles was established.

The expanded polystyrene thus obtained had a pentane content of 2.5% by weight and was used after less than one hour directly for the production of a light wood-containing substance.

### A-V) Comparison: Preparation of the Expanded Polystyrene Having a Commercial Pentane Content

As described in A) above, an expandable polystyrene was prepared, but 6.5 parts by weight of pentane were used.

This product was treated in a preexpander as described in A) and a bulk density of 50 kg/m³ was established. The pentane content of this expanded polystyrene was 5% by weight.

### B) Production of a Multilayer Wood-Base Material with and without Component B) with the Use of Urea-Formaldehyde Glues

### B1) Glue Liquors for the Corresponding Layers

Kaurit® glue KL 347 from BASF SE, a UF resin, was used as the glue. The glue was mixed with further components (see table below) to give a glue liquor. The composition of the glue liquors for the covering layer and the middle layer are shown in the table below.

TABLE 1
Glue liquors for covering layer and middle layer

| | Covering layer | Middle layer |
|---|---|---|
| Components | (parts by weight) | (parts by weight) |
| KL 347 liquid | 100.0 | 100.0 |
| Ammonium nitrate solution | 1.0 | 4.0 |
| (52% strength) | | |
| Solid urea | 0.5 | 1.3 |
| Hydro Wax 560 (60% strength) | 0.5 | 0.8 |

### B2) Production of the Three-Layer Wood-Base Materials According to the Invention

The glue coating and the pressing of the wood chips are effected analogously to customary methods for the production of particle boards.

### B2.1) Glue Coating of the Middle Layer Material

Coarse spruce chips, expanded polystyrene (prepared according to A) above) were mixed with the glue liquor for the middle layer (according to table 1 above) in a mixer so that the amount of glue (as solid) was 8.5% by weight, based on absolutely dry wood plus expanded polystyrene. The amount of the expanded polystyrene, based on the total amount of absolutely dry wood plus expanded polystyrene, was 10% by weight.

### B2.2) Glue Coating of the Covering Layer Material

Fine spruce chips were mixed with the glue liquor for the covering layer (according to table 1 above) in a mixer so that the amount of glue (as solid) was 8.5% by weight, based on absolutely dry wood.

### B3) Comparative Experiments

B3.1) Glue Coating of the Middle Layer Material (Expanded Polystyrene from Expandable Polystyrene of Relatively High Pentane Content)

Coarse spruce chips, expanded polystyrene (prepared according to A-V) above) were mixed with the glue liquor for the middle layer (according to table 1 above) in a mixer so that the amount of glue (as solid) was 8.5% by weight, based on absolutely dry wood plus expanded polystyrene. The amount of expanded polystyrene, based on the total amount of absolutely dry wood plus expanded polystyrene, was 10% by weight.

### B3.2) Glue Coating of the Covering Layer Material

As described in B2.2 above.

### B4) Pressing of the Glue-Coated Chips

### B4.1) Experiments According to the Invention

The material for the production of a three-layer particle board was sprinkled into a 30×30 cm mold. First, the covering layer material, then the middle layer material and finally once again the covering layer material were sprinkled. The total mass was chosen so that, at the end of the pressing process, the desired density resulted in the case of a required thickness of 16 mm. The mass ratio (weight ratio) covering layer material:middle layer material:covering layer material was 17:66:17 in all experiments.

The covering layer material used was the mixture described above under B2.2). The middle layer material used was the mixture described above under B2.1).

After the sprinkling, precompression was effected at room temperature, i.e. “cold”, and then pressing was effected in a hot press (pressing temperature 210° C., pressing time 210 s). The required thickness of the board was 16 mm in each case.

### B4.2) Comparative Experiments

### B4.2.1) (With Expanded Polystyrene of Relatively High Pentane Content)

Procedure analogous to B4.1, but with the middle layer material from B3.1) and the covering layer material from B3.2).

### B4.2.2) (Without Expanded Polystyrene)

B4.2.2.1) Glue Coating of the Middle Layer Material (without Expanded Polystyrene)

Coarse spruce chips were mixed with the glue liquor for the middle layer (according to table 1 above) in a mixer so that the amount of glue (as solid) was 8.5% by weight, based on absolutely dry wood.

### B4.2.2.2) Glue Coating of the Covering Layer Material

Fine spruce chips were mixed with the glue liquor for the covering layer (according to table 1 above) in a mixer so that the amount of glue (as solid) was 8.5% by weight, based on absolutely dry wood.

A three-layer board was produced by pressing analogously to B4.1.

### C) Investigation of the Multilayer Wood-Based Materials

### C1) Density

The density was determined 24 hours after production according to EN 1058.

### C2) Transverse Tensile Strength

The transverse tensile strength was determined according to EN 319.

The results of the tests are listed in table 2.

TABLE 2

| | | | Three-layer wood- |
|---|---|---|---|
| | Three-layer | | base material |
| | wood-base | Three-layer | according to |
| | material | wood-base material | B4.2.1): |
| | according | according | comparison |
| | to B4.1), | to B4.2.2): | (expanded |
| | according | comparison (no | polystyrene, |
| | to the | expanded | relatively high |
| | invention | polystyrene) | pentane content) |
| Density, kg/m³ | 467 | 450 | 464 |
| Transverse | 0.48 | 0.34 | 0.49 |
| tensile strength | | | |
| N/mm² | | | |

It is evident that the wood-base material B.4.1 according to the invention, obtained with expanded polystyrene of low pentane content, has, with the accuracy of measurement, the same transverse tensile strength as that with expanded polystyrene of high pentane content (B4.2.1), but significantly better values than wood-base material without expanded polystyrene (B4.2.2), having a comparable density.

The advantage of the invention is to be seen, inter alia, in that the emissions of blowing agent, for example pentane, during the production and during the processing of expanded plastics particles, for example expanded polystyrene particles, are substantially reduced, which, in addition to the positive effects on the atmosphere, has an advantageous influence on the safe handling of the expanded plastics particles, for example expanded polystyrene particles, the product properties of the wood-base material still being good.

1-12. (canceled)

13. A process for the production of a light lignocellulose-containing substance having an average density in the range from 200 to 600 kg/m³, in which, in each case based on the lignocellulose-containing substance:
A) from 30 to 95% by weight of lignocellulose particles;
B) from 1 to 25% by weight of expanded plastics particles having a bulk density in the range from 10 to 100 kg/m³;
C) from 3 to 50% by weight of a binder selected from the group consisting of aminoplast resin, phenol-formaldehyde resin and organic isocyanate having at least two isocyanate groups and, if appropriate,
D) additives
which comprises mixing components A)-D) and then pressing at elevated temperature and under elevated pressure, wherein the expanded plastics particles are obtained from expandable plastics particles with a content of blowing agent in the range from 0.01 to 4% by weight, based on the expandable plastics particles.

14. The process according to claim 13, the component B) is a styrene homopolymer or styrene copolymer.

15. The process according to claim 13, the blowing agent is an aliphatic C3- to C10-hydrocarbon.

16. The process according to claim 13, the component C) comprises an aminoplast resin.

17. A process for producing expandable plastics particles which are used in a light lignocellulose-containing substance which comprises mixing an expandable plastic particles which have a bulk density in the range from 10 to 100 kg/m³ with a content of blowing agent in the range from 0.01 to 4% wherein the light lignocellulose-containing substance having an average density in the range from 200 to 600 kg/m3, comprising, based in each case on the lignocellulose-containing substance:
A) from 30 to 95% by weight of lignocellulose particles;
B) from 1 to 25% by weight of said expanded plastics particles having a bulk density in the range from 10 to 100 kg/m³;
C) from 3 to 50% by weight of a binder selected from the group consisting of aminoplast resin, phenol-formaldehyde resin and organic isocyanate having at least two isocyanate groups and, optionally,
D) additives.

18. The process according to claim 17, the component B) is a styrene homopolymer or a styrene copolymer.

19. The process according to claim 17, the blowing agent is an aliphatic C3- to C10-hydrocarbon.

20. The process according to claim 17, the component C) comprises an aminoplast resin.

21. A process for the production of a multilayer lignocellulose material which comprises at least three layers, only the middle layer or at least some of the middle layers comprising the light lignocellulose-containing substance made from the process as claimed in claim 13, wherein the components for the individual layers being placed in layers one on top of the other and pressed at elevated temperature and elevated pressure, and the expanded plastics particles B) being obtained from expandable plastics particles with a content of blowing agent in the range from 0.01 to 4% by weight, based on the expandable plastics particles.

22. The process according to claim 21, the outer covering layers comprising no component B).

23. A multilayer light lignocellulose-containing substance which is obtained from the process as claimed in claim 21.

24. A process for the production of an article which comprises the multilayer light lignocellulose-containing substance as claimed in claim 23.

25. A process for the production of an article which comprises the light lignocellulose-containing substance as claimed in claim 13.

26. The process as claimed in claim 24, wherein the article is used for the production of pieces of furniture and furniture parts, of packaging materials, in house building or in interior finishing.

27. The process as claimed in claim 25, wherein the article is used for the production of pieces of furniture and furniture parts, of packaging materials, in house building or in interior finishing.
